(19) United States
(12) Patent Application Publication
(10) Pub. No.: US 2006/0050894 A1
(43) Pub. Date: Mar. 9, 2006

(54) Entertainment system

(76) Inventors: Michael Lehmann Boddicker, Encino, CA (US); Lou Woolf, Sherman Oaks, CA (US); Keith Heavenridge, Encino, CA (US)

Correspondence Address: Marshall E. Rosenberg, Esq.;Registered Patent Attorney, P.O. Box 966, Woodland Hills, CA, 91365-0966, US

(21) Appl. No.: 10/933,759

(22) Filed: Sep. 3, 2004

(51) Int. Cl. H04B 3/00

(52) U.S. Cl. 381/77; 381/86

(57) ABSTRACT

A system of and method for installation and use thereof that provides for application of karaoke system components applicable either for desktop or mobile environments, including integrated or retrofittable components in a manner that allows desktop users/vehicle occupants to selectively utilize in combination a karaoke system together with audio and related operating systems to provide an integrated karaoke system.

### CROSS-REFERENCE TO RELATED APPLICATIONS

not applicable

### STATEMENT RE: FEDERALLY SPONSORED RESEARCH/DEVELOPMENT

not applicable

### BACKGROUND OF THE INVENTION

1. Field of the Invention

The present invention relates to entertainment systems, and more particularly, to entertainment systems for either stationary or mobile use (i.e. in motor vehicles), either as an integral system or for modular application as a retrofit, and for the latter case utilizing in situ vehicle components to support and broadcast one or more sound streams, or at or adjacent a desk top or other location.

2. Description of the Related Art

Karaoke is an increasingly popular form of entertainment which allows enables live participation, to sing along with a desired soundtrack of a virtually unlimited spectrum of songs. Originally conceived in Japan, karaoke is widely enjoyed throughout the U.S. and the world, in private homes as well as in clubs and restaurants. Karaoke is a Japanese abbreviated compound word which translates roughly as “empty orchestra.” “Kara” comes from “karappo” meaning empty, and “oke” is the abbreviation of “okesutura,” or orchestra. Karaoke is used to describe any sing-a-long track which may optionally be displayed on a TV or video screen. Usually, a music recording consists of vocals and accompaniment. Those music recordings in which only the accompaniment is recorded are called karaoke CD's or karaoke discs.”

Karaoke systems are known. For example, U.S. Pat. Nos. 5,250,747; 5,454,723; 5,473,106; 5,484,291; 5,518,408; 5,609,486; 5,679,911; 5,684,261; 5,739,452; and 5,811,708 all describe karaoke-directed systems which generally allow separate input streams of one or more voices, together with a music soundtrack to be amplified, adjusted and mixed together and outputted to an audio speaker for broadcasting to an audience. U.S. Pat. No. 5,713,633 describes a chamber in a backrest assembly that may receive and support a karaoke system. U.S. Pat. No. 4,866,515 describes an individual entertainment system installed in each seat back of an airplane with entertainment signals transmitted from a central unit to each individual entertainment system.

It will be appreciated that such prior art apparatuses are generally available in two formats: portable and component style. A prior art portable player, typically available as an “all-in-one player” commonly includes a music soundtrack player in one or more formats including cassette and CD, one or more inputs for a like number of microphones (for solo or duet singing as desired), and a built-in speaker for outputting the combined sound stream. Some prior art karaoke players may also include a recording device to capture the output, pitch controller, reverb controller, and audio output jacks.

Alternatively, component-style prior art apparatuses component karaoke players are similar to CD players in size and function except that they have several additional features: two or more microphone inputs with separate microphone volume controls and a digital key and digital echo control. The component player does not have its own speaker or amp so it must be connected to a home or professional sound system to drive the sound. Similar to portable karaoke players, the component player has a video output jack for connection to a home TV or to a professional monitor. The typical karaoke component player does not have its own audio recorder so any tapes/CDs must be made using a separate tape recorder.

The component players are typically multi-disc systems, either carousel or drawer. The component system also has many programmable features that make it easy to cue specific discs and tracks, which are features considered important by professional karaoke “jockeys”.

Despite the prior art described above, however, there are additional locals and venues where the inventors of the present invention have determined there is a desire to utilize the karaoke concept, including mobile applications. There is known in the prior art a car-mounted audio system wherein the parts which an operator needs for operation of the system i.e., the operator controls such as knobs and buttons, the display section for displaying operational states, and the drive deck (the mechanical components), are provided in a console unit or in the dashboard, and the other parts are provided in hidden-away locations as much as possible. This arrangement provides the freedom of combining each of the units with other units and it is contemplated that various different types of components, e.g., personal radio communication devices, compact disk units and so, can be combined to expand the system as desired. See FIG. 10, showing certain prior art structure. In particular, in FIG. 10, the components shown in double-line enclosures are provided in the console or dashboard unit, which comprises operator control section 16, display section 17, and a deck section 18. The parts shown in single-line enclosures are provided in hideaway locations. The latter include a tuner unit 19, a preamplifier unit 23, a unit 24 for singing an air to the tune of a melody recorded on a recording medium such as magnetic tape (hereinafter referred to as “the karaoke unit” or “the karaoke apparatus”), a graphic equalizer unit 25, an ASL unit 26 (an apparatus to control the volume automatically), and a power amplifier unit 27. These components comprise the audio signal processing portion of the system.

The units are connected to one another by a connecting cable 20. The cable 20 is composed of a microcomputer bus line 21 and a two-core shielding connection line 22 which comprises an L & R channel line and a ground line. Microcomputer 1 and a plurality of microcomputers 2 are respectively connected via the microcomputer bus line 21, wherein the microcomputer 1 works as a master source and each microcomputer 2 works as a terminal satisfying its unit specification.

Each of the microcomputers 1 and 2 are connected with the circuits 4 to 11 within the units 16-26. When the circuits 4, 5 of the operator control section and the display section do not have any signal sources, then they would not be connected with the audio bus line 22.

A microphone 12 for the karaoke apparatus is connected with the circuits 9 of the karaoke unit 24. A microphone 13 for detecting white or pink noise (i.e. ambient characteristics) is connected with the circuit 10 of the graphic equalizer 25. Further, a microphone 14 for detecting any running or ambient noise is connected with the circuit 11 of the ASL unit 26. In addition, speakers 15 for the L & R channel are connected with the power amplifier units 27. When the operator manipulates the operator controls in this prior art audio equipment, each unit is controlled by the microcomputer 1 and a result of the control state is displayed on the display 17. During operation of deck 18, an audio signal from the circuit 6 is fed to the audio source bus line 22 shown by the dotted line in FIG. 1 and is fed to the circuit 8 of the preamplifier unit 23, wherein signal processing to effect volume control and tone control is performed. The processed signal is fed to the audio signal line 28, which is connected with the power source. Therefore, conventional audio processing is done toward said signal so that finally the speaker 15 is driven through the power amplifier 27.

In the case of the karaoke operation, the audio signal is detected through the microphone 12 connected with the circuit 9 of the karaoke unit 24. This detected signal is subjected to echo processing and mixing and fed to the audio signal line 28. The microphone 13 connected with the graphic equalizer 25 is used for controlling the automatic frequency characteristic and detects the pink noise transmitted inside the car. That is to say, the pink noise originated at the circuit 10 is amplified through the power amplifier and put on the air over the speaker 15 in the car. Owing to the fact that the microphone 13 then detects the sounded pink noise, the circuit 10 discriminates the level at each frequency processed by the graphic equalizer and controls the equalizer so as to produce a flat frequency characteristic. Since the microphone 14 of the ASL unit 26 detects the running noise inside the car, the circuit 11 controls the volume and the tone, etc., on the base of the noise for compensating the Masking Phenomenon which is brought by the running noise. Audio signal system processing of the prior art includes audio outputs of the sources, i.e., the deck section, the tuner unit and other source units, are connected to the audio source bus line as the current source through a voltage-current conversion circuit 29. The signal currents from the plural sources are fed to a current-voltage conversion circuit 30 of the preamplifier 23 to convert the currents into voltage, which are fed to another audio unit through the volume tone circuit 31. Since the car-mounted audio equipment of the prior art is configured as mentioned above, separate microphones have to be provided for the karaoke unit 24, the graphic equalizer unit 25, and the ASL unit 26.

However, known of the known prior art of record is adaptable for use with control or non-control surfaces of the motor vehicle to which the equipment is mounted for use. In particular, the prior art fails to provide for application of karaoke system components applicable either as built-in (i.e. integrated) or retrofittable components in a manner that allows the vehicles's occupants to selectively utilize in combination a karaoke system together with audio and related vehicular operating systems to provide an integrated karaoke system.

Accordingly, there exists a need for a system of method of installation and use thereof that provides for application of karaoke system components applicable either as built-in (i.e. integrated) or retrofittable components in a manner that allows the vehicles's occupants to selectively utilize in combination a karaoke system together with audio and related vehicular operating systems to provide an integrated karaoke system.

### OBJECTS AND SUMMARY OF THE INVENTION

Accordingly, it is an object of the invention to provide a novel entertainment system for a motor vehicle.

It is another object of the invention to provide a novel entertainment system that is integrated into the stereo system of a motor vehicle.

It is a still further object of the invention to provide a novel entertainment system that may be retrofitted and integrated into the radio system of the vehicle, whereby the components of the entertainment system are selectively integrated into control or noncontrol units and surfaces of the vehicle.

It is yet another object of the invention to provide a novel entertainment system of the invention that is integrated into a unit for installation into a vehicle when it is being assembled.

It is yet a further object of the invention to provide a novel input device for use in connection with an audio system, whether mobile or fixed within a mobile vehicle or for fixed land application, the novel input device providing karaoke-style user participation in connection with an audio stream produced by the audio system.

According to the present invention, a system of and method for installation and use thereof that provides for application of karaoke system components applicable either as built-in (i.e. integrated) or retrofittable components in a manner that allows the vehicles's occupants to selectively utilize in combination a karaoke system together with audio and related vehicular operating systems to provide an integrated karaoke system. These objects and other objects which will become apparent from the following specification are provided by an entertainment system for a motor vehicle which comprises a radio or other source of downloadable music data, a source of recorded music connected thereto, at least one loudspeaker, and at least one transducer arranged to receive the voice of an occupant of the vehicle and to produce an electronic signal output, and an electronic circuit for receiving said signal and for coupling the signal output to said radio. Operation of the system is provided by input to input devices such as but not limited to impact pads adapted to be fitted to a variety of surfaces of the motor vehicle, such as the steering wheel, dashboard, seat back, console, other interior panels, as well as operating controls such as but not limited to levers, switches, and other controls. It will be appreciated that operation of the system is not limited to the interior of the vehicle, but may be extended to adjacent areas such as a pick-up bed, trunk or even external surfaces of the vehicle designated for use in conjunction with the system.

### BRIEF DESCRIPTION OF THE DRAWINGS

FIG. 1 is a diagrammatic view of the entertainment system of the present invention mounted to a mobile environment, such as an automobile.

FIG. 2 is a front elevational view of operative aspects of the present invention mounted adjacent to a steering wheel of an automobile.

FIG. 3 is a partial, detailed view of the components and mounting structure shown in FIG. 2.

FIG. 4 is a cross-sectional view of the percussion components shown in FIGS. 2 and 3, further showing mounting structure for mounting the percussion components to a steering wheel of an automobile.

FIG. 5 is a perspective view of an alternate embodiment of one aspect of the invention, in which the percussion and optionally various karaoke system components are mounted to and supported by a cantilever arm secured to a structure of the automobile in which the system is installed.

FIG. 6 is a perspective view of the karaoke system housing.

FIG. 7 is a front elevational view of an in-dash head unit for the karaoke/entertainment system supported by the automobile.

FIG. 8 is a diagrammatic view of the karaoke/entertainment system of the present invention, showing input and output elements together with operational circuitry.

FIG. 9 is a diagrammatic view of the karaoke/entertainment system of the present invention, showing additional input and output elements together with operational circuitry desired to provide a desired conditioned output audio signal as well as visual indicators thereof.

FIG. 10 is a diagrammatic view of an entertainment system of the prior art, showing common operational elements.

### DETAILED DESCRIPTION OF THE PREFERRED EMBODIMENTS

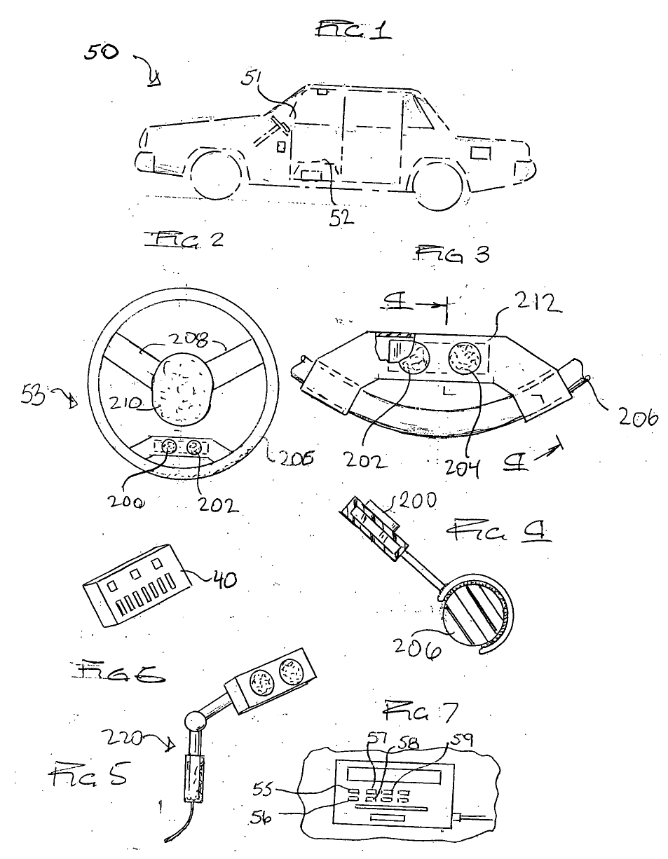

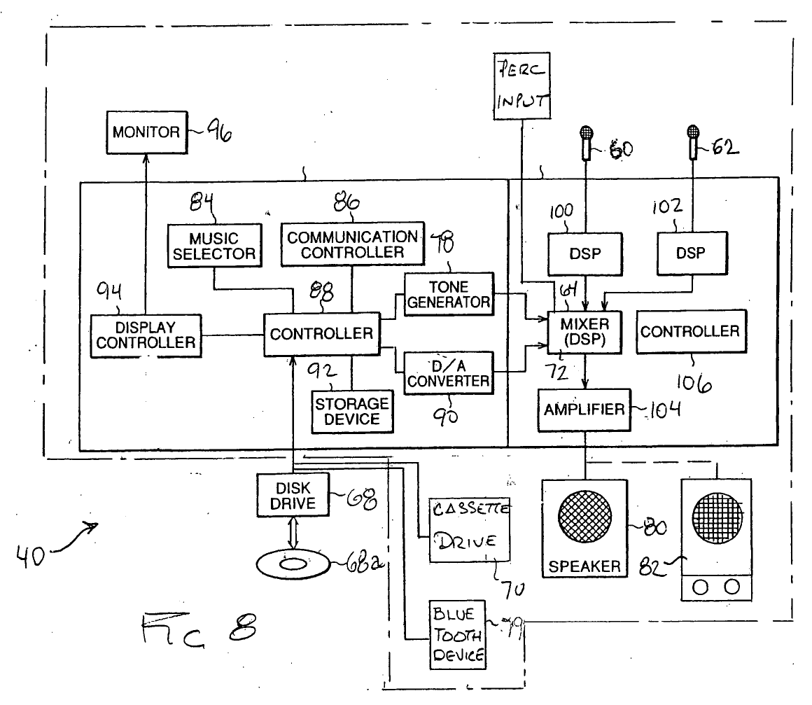

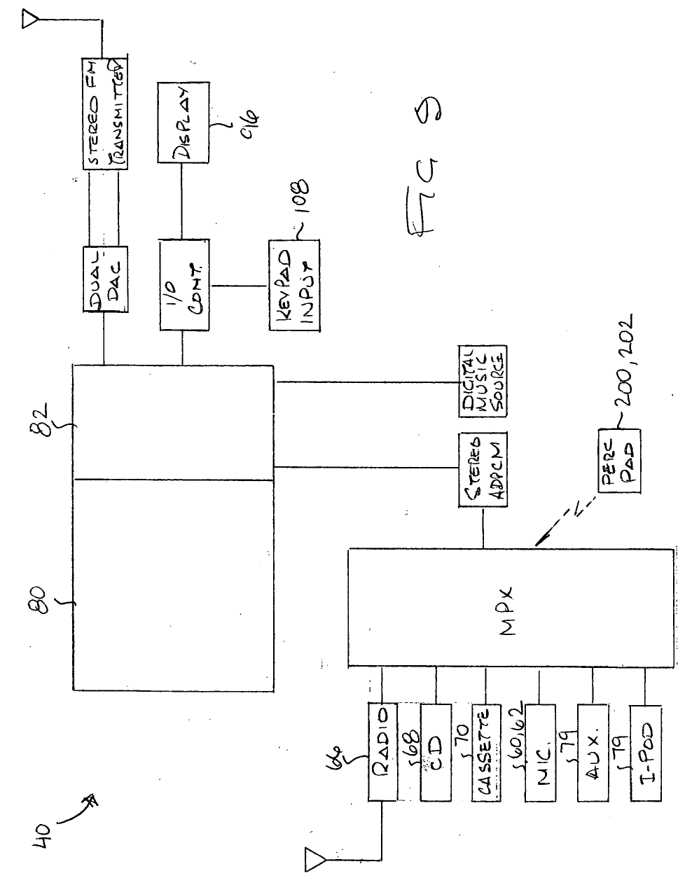

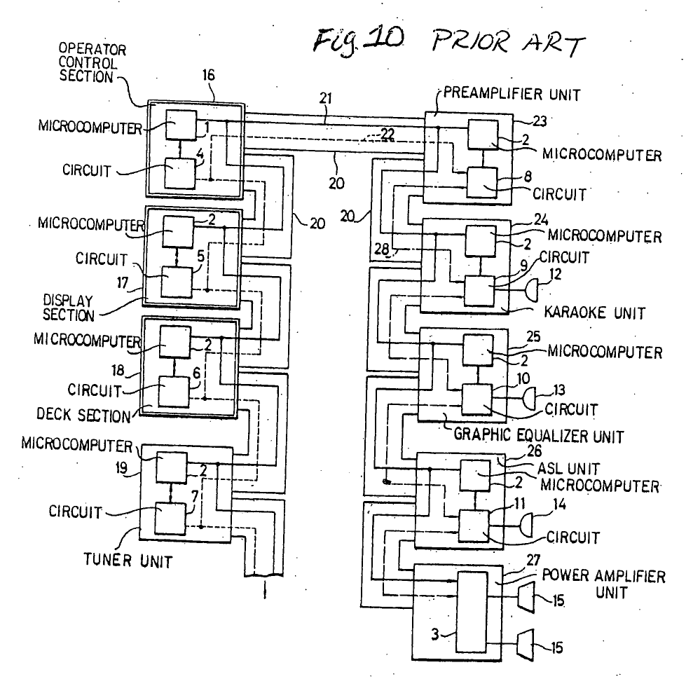

Referring now to the drawings wherein like numerals designate like and corresponding parts throughout the several views, FIG. 10 shows a diagrammatic rendering of a related prior art system, FIGS. 1-9 showing the present invention as will be more fully described below. Specifically, and with reference to FIG. 10, the components shown in double-line enclosures are provided in the console or dashboard unit, which comprises operator control section 16, display section 17, and a deck section 18. The parts shown in single-line enclosures are provided in hideaway locations. The latter include a tuner unit 19, a preamplifier unit 23, a unit 24 for singing along with a tune of a melody recorded on a recording medium such as magnetic tape (hereinafter referred to as “the karaoke unit” or “the karaoke apparatus”), a graphic equalizer unit 25, an ASL unit 26 (an apparatus to control the volume automatically), and a power amplifier unit 27. These components comprise the audio signal processing portion of the system.

The units are connected to one another by a connecting cable 20. The cable 20 is composed of a microcomputer bus line 21 and a two-core shielding connection line 22 which comprises, for example, an L & R channel line and a ground line. Microcomputer 1 and a plurality of microcomputers 2 are respectively connected via the microcomputer bus line 21, wherein the microcomputer 1 works as a master source and each microcomputer 2 works as a terminal satisfying its unit specification. It will be appreciated that additional multichannel music formats including by way of example only, 5.1, 6.1 and 7.1 formats. That is, the terms 5.1, 6.1, and 7.1 mean that there are five, six, or seven main speakers, plus a subwoofer, in the playback system. (A subwoofer reproduces the LFE channel recorded on 5.1 soundtracks, plus any bass the main speakers cannot handle.) The difference in formats is in the number of surround speakers: two in a 5.1 system, three in a 6.1 system, and four in a 7.1 system. An additional format that may be implemented with the present invention includes wall surfaces converted into transducers as will be appreciated by the skilled artisan.

Each of the microcomputers 1 and 2 are connected with the circuits 4 to 11 within the units 16-26. When the circuits 4, 5 of the operator control section and the display section do not have any signal sources, then they would not be connected with the audio bus line 22.

A microphone 12 for the karaoke apparatus is connected with the circuits 9 of the karaoke unit 24. A microphone 13 for detecting so-called pink noise is connected with the circuit 10 of the graphic equalizer 25. Further, a microphone 14 for detecting the running noise is connected with the circuit 11 of the ASL unit 26. In addition, speakers 15 for the L & R channel are connected with the power amplifier units 27. When the operator manipulates the operator controls in this prior art audio equipment, each unit is controlled by the microcomputer 1 and a result of the control state is displayed on the display 17. During operation of deck 18, the audio signal from the circuit 6 is fed to the audio source bus line 22 shown by the dotted line in FIG. 1 and is fed to the circuit 8 of the preamplifier unit 23, wherein signal processing to effect volume control and tone control is performed. The processed signal is fed to the audio signal line 28, which is connected with the power source. Therefore, conventional audio processing is done toward said signal so that finally the speaker 15 is driven through the power amplifier 27.

In the case of the karaoke operation, the audio signal is detected through the microphone 12 connected with the circuit 9 of the karaoke unit 24. This detected signal is subjected to echo processing and mixing and fed to the audio signal line 28. The microphone 13 connected with the graphic equalizer 25 is used for controlling the automatic frequency characteristic and detects pink noise transmitted inside the car. Thus, pink noise originated at the circuit 10 is amplified through the power amplifier and put on the air over the speaker 15 in the car. Owing to the fact that the microphone 13 then detects pink noise, the circuit 10 discriminates the level at each frequency processed by the graphic equalizer and controls the equalizer so as to produce a flat frequency characteristic. Since the microphone 14 of the ASL unit 26 detects the running noise inside the car, the circuit 11 controls the volume and the tone, etc., on the basis of that noise for compensating masking phenomenon which is brought by the running noise. Audio signal system processing of the prior art includes audio outputs of the sources, i.e., the deck section, the tuner unit and other source units, are connected to the audio source bus line as the current source through a voltage-current conversion circuit 29. The signal currents from the plural sources are fed to a current-voltage conversion circuit 30 of the preamplifier 23 to convert the currents into voltage, which are fed to another audio unit through the volume tone circuit 31. Since the car-mounted audio equipment of the prior art is configured as mentioned above, separate microphones have to be provided for the karaoke unit 24, the graphic equalizer unit 25, and the ASL unit 26.

It will be appreciated that the present invention beneficially utilizes this separation of components, in the manner to be more fully described below in connection with the discussion of the preferred embodiments of the present invention.

With reference now to FIGS. 2-9, and according to the present invention, a mobile environment such as an automobile 50 having a dashboard 51 or center console 52 positioned between the commonly-provided two front seats (not shown) of the vehicle 50 may be provided with karaoke operational controls 55 to 59 (FIG. 7), and a vehicle steering wheel 53 to accommodate the overall installation of entertainment system 40. Vocal input is provided via microphones 60, 62 respectively of the entertainment system of the invention, the microphones 60, 62 being mounted where desirable within the confines of the vehicle or even extendable to a location outside of the vehicle such as a pickup-bed or extendable to an extent that enables the vehicle-mounted system to function as part of a sound stage. System controls 55-59 adjust the level of signal output from each of the microphones 60, 62 in the vehicle 50. By way of example, control 55 adjusts the output of the microphone 60. Control 56 adjusts the output of the microphone of the microphone 62. For retrofitted systems, controls 55-59 may be contained in a separate enclosure, and optionally removable to enable vehicle-to-vehicle transfer. To achieve this objective, the bottom (or other portion) of the enclosure may have a removably securable attachment means such as a quick-release bracket or an adhesive strip for attachment to the console or other supporting structure of the vehicle 50.

As indicated above, the entertainment system of the invention is suitable for retrofitting to a vehicle. In the system illustrated, the output from microphones 60, 62 are controlled by variable amplifiers, which in turn are coupled to a first mixer 64, the output of which is coupled to, for example, a feedback or squeal suppressor. A receiving antenna is coupled to radio section having a radio receiver 66, the output of which and the outputs from CD player 68 and cassette player 70 or Bluetooth-enabled output devices 79 (e.g. I-Pod™) are coupled to a second mixer 72, the output of which is coupled to transmitter 74 which in turn is coupled to transmitting antenna 74. In operation, the variable amplifiers control the amplitude of the output of the microphones in order to adjust the differences in the singing voices of the occupants of the vehicle. The squeal suppressor and/or audio gate and/or echo cancellation serves to suppress the squeal or echo that would be induced in the system by the proximity of the microphones 60, 62 and the radio receiver 66. Through selection of the output from the radio receiver 66, the CD player 68 or the cassette player 70, mixer 64 mixes the selected output from the various selected input elements with the output from the squeal suppressor and feeds it to the transmitter, which transmits on an FM frequency on the FM dial that is not used for broadcast. The signal from the transmitting antenna is picked up by the receiving antenna of the car stereo radio (not shown), which is tuned to the selected FM frequency. The signal is amplified and coupled to the internal loudspeaker 80 or external loudspeaker 82 and adjusted by the fader and balance controls already present in the stereo system of the vehicle.

According to the invention, percussion inputs are provided via percussion pads 200, 202 operating through an electronic percussion controller, to generate outputs such as but not limited to acoustic and electronic drums, hand percussion instruments, sound effects or any other prerecorded or generated sampled sound. Percussion pads 200, 202 may be obtained from Pintech as Model NR6 Nimrod. As will be appreciated by the skilled artisan, the pads are playable by finger, hand or drum sticks, and outputs are directed via a MIDI, USB, Firewire or other data transmission output for triggering other sound sources, connecting to external sequencer whether contained in a cellular telephone, PDA, laptop computer or outboard musical or electronic device and ultimately being mixed with and outputted with a singer's voice output. As with other inputs, pads 200, 202 may be selectively mapped with different sound outputs to effect a desired sound effect. Pads 200, 202 are either selectively affixed to a desired surface, integrally formed therewith, or provided in an accessory. By way of example, pads 200, 202 with application to a motor vehicle steering wheel 53 may be affixed directed to the rim 206, spokes 208 or center hub 210 of the steering wheel, either removably or permanently. According to one embodiment, pads 200, 202 are mounted to a cross-bar 212 bridging a circumferential aspect of rim 206, either temporarily or permanently secured thereto. For a temporary securement, the cross-bar 212 is secured by one or more (two shown) c-clamp structures for partially embracing the rim 206 with a snap fit engagement, which provides only a nominally additional overall thickness to the steering wheel rim and thus does not hamper rotation of the steering wheel through the driver's hands during typical driving maneuvers. Alternatively, the pads may be integrally formed with any of those structures, or even provided within the structure of a steering wheel rim cover. According to yet a further embodiment, pads 200, 202 may be incorporated into a partial or full steering wheel cover with fixed or removably secured (e.g. via VELCRO™) cooperating engagement means) for permanent or temporary affixation as desired. Whatever the securement means, each pad 200, 202 includes a transducer section that transmits to a receiver, and that receiver wirelessly relays output signals to the system controller for desired signal mixing and manipulation prior to sound stream outputting. Accordingly, that wireless link enables application of the pads 200, 202 in its support housing to movable or non-movable surfaces as desired. According to yet a further embodiment of the invention, it is further contemplated that percussion pads 200, 202 may be incorporated into a vehicle structure including but not limited to the dash pad fronting the front passenger seats, or available surfaces in the vehicle's seats or door panels. Signal input in any of those remote locations is by wireless link (by Bluetooth, WiFi or the like transmission link) as will be appreciated by the skilled artisan.

For an off-steering wheel application, a cantilever support 220 is mounted at one end to a suitable support structure of the vehicle 50, the opposite end supporting the pads 200, 202 in the manner previously described, and adjustable via one or more pivot points 222 for the user's convenience. It will be understood that support 220 may be mounted to the dashboard, center console, floor, seat backs, seat frame, or A-, B- or C-pillars of the vehicular structure. It will be further

In addition, the basic entertainment of the system may be integrated into the automobile's stereo radio/CD/cassette player. The outputs of microphones are controlled by variable amplifiers, the output of each of which is coupled to the first mixer, the output of which in turn is coupled to the squeal suppresser, which performs the same functions as previously described. The output of the squeal suppresser may then be coupled to additional mixers as necessary and desired. The selected output of the radio, CD player or cassette player is also coupled to the mixers, where the selected signal is mixed with the output from the squeal suppresser. In turn, the mixers are coupled to the output amplifiers, which in turn are coupled to the loudspeakers. The fader controls for the integrated entertainment system of the invention are present on the radio/CD/cassette section of the integrated unit. An input device such as keypad 108 may be utilized for control or labeling purposes.

Further illustrated is a more sophisticated system intended for retrofitting into a vehicle as well as for desktop or non-vehicular data manipulation. Microphones 91 to 95 are respectively coupled to preamplifiers 161 to 165, the outputs of which are respectively coupled to pitch controllers 131 to 135. Pitch controllers and correctors 131 to 135 are intended to counteract any off-key singing. Pitch controllers 131 to 135 in turn are respectively coupled to echo controllers 136 to 140, each of which in turn is coupled to USARTs 151 to 155 respectively. USARTs 151 to 156 are present on microprocessor chip 150, as is ROM 157. Receiving antenna 97 receives radio broadcast frequencies for radio 98. Radio 98, CD 99, cassette 100 and auxiliary 104 are coupled to multiplex 105, which in turn is coupled to stereo ADPCM 106. ADPCM 106 is coupled to USART 156. An alternative coupling to USART 156 for CD 99 is shown by the dotted line. Also coupled to microprocessor 150 is digital music source 166, which may be a hard drive or a memory card, etc. Microprocessor 150 is coupled to dual DAC 148, which in turn is coupled to stereo FM transmitter 102, which broadcasts via antenna 103 to an unused frequency on the FM dial of the radio of the vehicle. The dial is tuned to receive the frequency being broadcast from transmitter 102. Also coupled to microprocessor 150 is input/output controller 167, which receives control input by means of keypad input 168. The status of the system and the input may be viewed on a display 169, which may be an LCD display.

The power source for the systems in may be the vehicle's electrical system, i.e., the vehicle's battery. The systems may be connected to the vehicle's electrical system through the vehicle's cigarette lighter socket. Alternatively, they may be hardwired to the electrical system. The systems may instead be operated from internal batteries. As described above, non-mobile applications, including but not limited to desk-top applications, according to the invention are contemplated as suitable environments for data manipulation in the manner described.

The foregoing specification and drawings have thus described and illustrated a novel entertainment system for a motor vehicle. Many changes, modifications, variations and other uses and applications of the subject invention will, however, become apparent to those skilled in the art after considering this specification, which discloses the preferred embodiments thereof. All such changes, modifications, variations and other uses and applications which do not depart from the spirit and scope of the invention are deemed to be covered by the invention, which is to be limited only by the claims which follow.

What we claim is:

1. In an entertainment system for a motor vehicle comprising a first sound source which produces a first output signal, a second sound source of recorded music which produces a second output signal, a switch coupled to the first sound source and the second sound source for selecting one of said first and second signals and passing said selected signal to a third signal output, at least one loudspeaker and circuit means for connecting said third signal output to said loudspeaker, the improvement comprising at least one input transceiver arranged to be mixed with a voice of an occupant of the vehicle and to produce a fourth output signal in response thereto, an electronic mixer circuit being coupled to said connecting means to supply the mixed signal to the loudspeaker.

2. An entertainment system as claimed in claim 1, wherein there are at least two input transceivers present in the system, each arranged to receive the voice of a different occupant of the vehicle.

3. An entertainment system as claimed in claim 2, wherein the electronic signal output from each transceiver is coupled to said mixer circuit.

4. An entertainment system as claimed in claim 3, wherein controls for said mixer circuit are present on a control or non-control surface of the vehicle.

5. An entertainment system as claimed in claim 1, wherein the transceiver is affixed to a steering wheel of the motor vehicle in proximity to the seatbelt wearer's mouth.

6. An entertainment system as claimed in claim 1, wherein the transceiver is disposed on a surface of the vehicle facing an occupant seated within the vehicle.

7. An entertainment system as claimed in claim 5, wherein the transceiver is disposed on a hub of the steering wheel.

8. An entertainment system as claimed in claim 1, wherein said at least one transceiver is disposed on a dashboard facing an occupant of the vehicle.

9. An entertainment system as claimed in claim 1, wherein said at least one transceiver is a directional microphone.

10. An entertainment system as claimed in claim 9, wherein there is present one microphone for each occupant of the vehicle, the output of each microphone is coupled to a variable amplifier, the output of which is in turn coupled to an auxiliary mixer circuit, the output of the auxiliary mixer circuit is coupled to a feedback or squeal suppressor and wherein the output of said suppressor is said fourth signal which is coupled to said mixer circuit.

11. An entertainment system as claimed in claim 1, further comprising a feedback or squeal suppressor for suppressing feedback from the loudspeaker to the at least one transceiver.

12. An entertainment system as claimed in claim 1, wherein the transceiver is a percussion input device.

13. In an entertainment system comprising a sound-generating communication device which produces a first output signal, a source of recorded music which produces a second output signal, a switch coupled to the communication device and the recorded music source for selecting one of said first and second signals and passing said one signal to a third signal output, at least one loudspeaker and circuit means for connecting said third signal output to said loudspeaker, the improvement comprising at least one input transceiver arranged to be mixed and to produce a third output signal in response thereto, an electronic mixer circuit being coupled to said connecting means to supply the mixed signal to the loudspeaker.

14. An entertainment system as claimed in claim 13, wherein there are at least two transceivers present in the system, each arranged to receive a different input.

15. An entertainment system as claimed in claim 14, wherein the electronic signal output from each transceiver is coupled to said mixer circuit.

16. An entertainment system as claimed in claim 13, wherein the system is adapted for use in a mobile environment.

17. An entertainment system as claimed in claim 14, wherein controls for said mixer circuit are present on a control or non-control surface of the mobile environment.

18. An entertainment system as claimed in claim 17, wherein the mobile environment is a motor vehicle.

19. An entertainment system as claimed in claim 13, wherein the system is adapted for use in a desktop application.

20. An entertainment system as claimed in claim 13, wherein the communications device is a radio.

21. An entertainment system as claimed in claim 13, wherein the transceiver is a percussion input device.

22. An improvement for use in connection with an audio system operatively in a mobile environment, the audio system including a sound generator, at least one loudspeaker and circuit means for connecting output from the sound generator thereto, the improvement comprising a percussion input transceiver arranged to be mixed with output from the sound generator for supplying the mixed signal to the loudspeaker.

23. The input device as recited in claim 22, wherein the percussion input device is a drum.

24. The input device as recited in claim 21, wherein said mobile environment is a vehicle, said device being affixable on a control or non-control surface of the vehicle.

25. The input device as recited in claim 24, wherein the control surface is a steering wheel of the vehicle.

26. The input device as recited in claim 24, wherein the non-control surface is selected from the group including a dashboard surface, an armrest, a surface of a vehicle seat, and an interior surface of the vehicle.

27. The input device as recited in claim 22, wherein the sound generator is selected from the group including a radio receiver, a pre-recorded media player, and live vocal input.

28. The input device as recited in claim 22, wherein the input device is operatively linked with the audio system by wireless link.

29. The input device as recited in claim 22, wherein the input device is adapted for use in a desktop application.

30. The input device as recited in claim 22, wherein the mobile environment is selected from the group including vehicles designated to travel by land, sea and air.
